(19) United States
(12) Patent Application Publication
(10) Pub. No.: US 2009/0076705 A1
(43) Pub. Date: Mar. 19, 2009

(54) POWER MODULATED, DUAL FUEL, SMALL DISPLACEMENT ENGINE CONTROL SYSTEM

(76) Inventors: Robert L. Colesworthy, St. Charles, MO (US); Brian L. Butler, St. Charles, MO (US)

Correspondence Address: CHARLES C. MCCLOSKEY, 763 S. NEW BALLAS ROAD STE. 170, ST. LOUIS, MO, 63141, US

(21) Appl. No.: 12/209,917

(22) Filed: Sep. 12, 2008

Related U.S. Application Data
(60) Provisional application No. 60/972,128, filed on Sep. 13, 2007.

(51) Int. Cl. F02D 45/00

(52) U.S. Cl. 701/103; 123/575

(57) ABSTRACT

An engine capitalizes on the advantages of alternative fuels such as ethanol, E-85, and other alcohols, with a small displacement engine, two cylinders or more, and at least a divided fuel tank or alternatively two tanks. An electronic engine control module selects the fuel for operating conditions and delivers the fuel through separate injection systems. The module selects unleaded gasoline for starting, light load and light cruising conditions. Upon greater demands for engine power, the module adds or switches entirely to a secondary fuel such as alcohol, ethanol, E-85 or other ethanol/gasoline blends and reduces or eliminates the introduction of gasoline fuel. The secondary fuel provides more power than unleaded gasoline, thus reducing the engine displacement required for operating a vehicle under a variety of loads. The present invention seeks a substantial engine power increase, reduction in engine detonation, improved cold starting, re-evaluation of turbochargers, a decrease in gasoline consumption, and gasoline as the default fuel.

The engine control system allows a small and efficient engine to deliver increased power upon demand over conventional automotive engines. The system modulates boost pressure when using a secondary fuel for operations at an increased power level. The power level increase occurs from the combination of lower stoichiometric, or higher octane, fuel and increased dynamic intake pressures. The system maintains engine power as low, with little or no intake boost pressure, and the gasoline, 85 octane minimum, is delivered through injectors. When higher power is demanded, the system increases boost pressure, at intake, while a secondary power fuel (ethanol, E-85, alcohol and the like), is injected.

### CROSS REFERENCE TO RELATED APPLICATION

This non-provisional patent application claims priority to the provisional application having Ser. No. 60/972,128 filed on Sep. 13, 2007 by the same inventors and is commonly owned by the same assignee.

### BACKGROUND OF THE INVENTION

This power modulated, dual-fuel small displacement engine control system generally relates to internal combustion engines and more specifically to controlling a small-displacement engine to improve fuel mileage and lower emissions, while providing the same power as current larger displacement engines.

Presently, gasoline prices are high and the demand for higher mileage vehicles increases each year. Mileage can increase with proper tire inflation and operation of the vehicle by the driver. Mileage can increase with improved aerodynamic shaping of a vehicle and reduction in weight. Mileage can increase with effective pairing of transmissions and engines. However, all such existing means of improving fuel mileage have limits. Greater mileage improvements will likely come from re-evaluating engine designs and the fuels.

Recent governmental action has inspired development and deployment of engines that operate on ethanol, a liquid alcohol product commonly produced domestically from corn or other agricultural crops. Ethanol is blended with gasoline, with the highest content currently being the E-85 formulation. E-85 has up to 85 percent denatured ethanol blended with gasoline to produce a motor fuel that has lower harmful emissions than straight gasoline.

Seeking to accommodate both E-85 fuel and ordinary gasoline, auto manufacturers have developed and sell Flex Fuel™ vehicles that can operate on either fuel. All these vehicles have certain drawbacks due to compromises made to run either fuel. They all exhibit lower fuel mileage when run on E-85 and have cold-starting problems. While the cold-starting issues may annoy few people, lost fuel mileage becomes a problem for all who pay the rapidly increasing costs for gasoline.

Ethanol, as with other alcohols, has the potential to develop significantly higher power in an internal combustion engine compared to gasoline. Because current Flex Fuel™ vehicles are configured to operate under the constraints of gasoline, they effectively waste the most significant power-producing qualities of ethanol-enhanced fuels like E-85.

Over the years, systems have been developed that significantly boost engine power by increasing intake gas pressures. When more air and fuel enters the engine, more power is produced. Turbochargers accomplish this by recapturing some of the energy in the waste exhaust gases, then turning blades that pressurize the intake gases. Supercharging systems utilize mechanical energy (often belt-driven) from the turning engine crankshaft to drive blades or a pump to boost intake gas pressures and thereby increase engine power output. In either case, intake pressures and temperatures must be monitored and controlled in order to prevent destructive engine detonation. This is particularly a problem when the engine is run on ordinary gasoline.

Gasoline and ethanol blended fuels respond differently to intake pressure boost and have unique requirements for optimal operation in an engine. E-85 has a much higher octane rating (105) than any gasoline and a significantly lower stoichiometric ratio. When running on E-85, additional liquid fuel is required to maintain the proper air-to-fuel mixture. The added fuel has the benefit of cooling the intake mixtures, which helps to increase engine power and resolve problems of engine detonation.

Fundamentally, gasoline provides a better choice for pure fuel economy while cruising and cold-starting, but ethanol, E-85, and other alcohols have the potential to operate better during acceleration and situations of high engine load. E-85 and other ethanol-enhanced fuels also have fewer emissions and reduce the need for imported petroleum. The use of ethanol and E-85 fuels results in an overall reduction in the release of atmospheric carbon compounds, in particular carbon dioxide and carbon monoxide. Ethanol, E-85, and alcohol fuels also provide a cooling effect upon the engine as they have a greater latent heat of vaporization. In brief, injecting ethanol, E-85, or alcohol cools the intake charge better and serves as a protective measure against heat-related problems. An engine that capitalizes on the best features of both straight gasoline and the increasingly available E-85 has a waiting market in the current economic and regulatory environment. This is the achievement and differentiation of the unique control system described herein.

### DESCRIPTION OF THE PRIOR ART

Over the years, various dual fuel and multiple fuel engines, components, methods, and devices have sought the benefits of fuels beyond gasoline. The prior art has supplied two fuels through a common fuel injection system, used parts that operate under two fuels, and provided various engine adjustments during usage of two or more fuels. Various systems have sought to couple a liquid petroleum fuel with a gaseous petroleum fuel. Other systems have utilized variable boost and variable compression configurations. However, these systems are not designed to operate a small displacement engine with the efficiency and benefits of the current invention.

None of the prior art systems have taken full advantage of the octane and performance capabilities of ethanol-enhanced fuels and combined that with a system that controls engine power by modulation of intake boost pressures and other engine functions to allow a very small displacement engine (reduced by at least a third as in the present invention) to operate with such increased efficiency and power and do not address attendant issues in cold startup and other vehicle operational requirements.

The prior art includes the patent to Brown et al. U.S. Pat. No. 4,305,350 that shows a relatively recent dual fuel system. This patent has two fuel tanks that release fuel to two carburetors, each has a venturi throat and the two throats come together at an adapter means. The adapter means selects which carburetor supplies fuel to a common manifold. Similar to the present invention, this patent describes usage of two fuel tanks to deliver fuel. However, this patent lacks separate injection systems for each fuel and electronic sensors as in the present invention and does not modulate intake boost pressures and other engine functions required to operate a small-displacement engine with power and efficiency.

The patent to Graf, U.S. Pat. No. 5,450,832 describes another dual fuel system that adapts to the existing electronic fuel injection system of a vehicle. This patented system has a pilot valve that delivers an alternate fuel, primarily a pressurized gaseous fuel such as compressed natural gas, into an electronic fuel injector. The pilot valve receives commands from the electronic control module during operation. This patented system supplies two fuels to an engine and follows commands from the on-board ECM. But this system lacks a separate injection system as in the present invention and uses a pressurized gaseous alternate fuel not seen in the present invention. It also does not modulate intake boost pressures and other engine functions required to operate a small-displacement engine with power and efficiency.

Then, the patent to Ristau, U.S. Pat. No. 1,541,851 shows a dual fuel supply system of some age. This patented system has two carburetors with separate controls that allow for independent operation of each carburetor. During usage of this system upon an engine, the engine can be fed fuel by one or both carburetors and one carburetor can be removed while the other supplies fuel. This patent covers a fuel supply system in general and carburetors in particular and mentions boost pressure modulation.

The patent to Walker, U.S. Pat. No. 3,718,000 builds upon other dual fuel systems but has a temperature activated control. The Walker engine operates upon gaseous fuel below a certain temperature and liquid fuel above that temperature. During starting of an engine, gaseous fuel produces fewer emissions than liquid fuel and is thus desirable to reduce emissions during one portion of engine operations. This engine includes a temperature sensor that delays usage of liquid fuel until the emissions' catalyst reaches a warmer temperature. This patent shows others using two fuels to operate an engine like the present invention. However, this patent refers to a gaseous second fuel and relies upon a temperature sensor as opposed to ECM for engine performance in the present invention. It does not provide for intake boost pressure control required to operate a small-displacement engine with power and efficiency.

The patent to Barber, U.S. Pat. No. 4,323,046 has another dual fuel system with petroleum and non-petroleum fuels. This system provides gasoline through a carburetor to an engine and alternatively vaporized fuel directly to the engine. This system has two accelerators and the operator of the system can choose which fuel to use. This system has a heating means to vaporize the liquid non-petroleum fuel. Unlike the present invention, this system does not use separate injection systems and does not use an ECM, nor does it control intake boost pressures and other engine functions for a small-displacement engine.

The patent to Bees et al. U.S. Pat. No. 5,658,013, has a fuel tank for both liquid and gaseous fuels where a housing secures between the rails of a vehicle and more than two storage cylinders locate within the housing. The cylinders contain gaseous fuel while the space outside of the cylinder within the housing holds the liquid fuel. The present invention utilizes two tanks or a divided single tank that contain the primary and secondary liquid fuels.

The patent to Cohen et al., U.S. Pat. No. 6,035,837 shows another dual fuel system for engines. This patented system has two fuel tanks providing fuel to a selective common valve that admits one of the two fuels to a common fuel rail. The fuel rail delivers the selected fuel to the injectors. This patent shows dual fuel tanks with an electronic control unit to regulate usage of the fuels. Unlike the present invention, the system is not designed to introduce a secondary low-stoichiometric liquid fuel while modulating intake boost pressures for operating a small displacement engine with adequate power.

The patent to Nelson et al., U.S. Pat. No. 6,276,345 has an adaptor for liquid fueled carburetors to accept gaseous fuel. This adaptor mounts to the air intake of a carburetor and selectively allows gaseous fuel or air to enter the carburetor. This patent has two fuels provide through a common carburetor. The present invention utilizes liquid fuels only and utilizes fuel injectors, not carburetors

The patent to Deutsch, U.S. Pat. No. 6,591,817, has a dual fuel control method and a system. This system has two tanks of fuel that can supply an engine. The system also has a manual fuel selector switch. This method uses an oxygen sensor and an engine control unit to regulate the transition from gasoline to a second fuel. The method seeks to improve fuel economy and reduce emissions by transitioning between liquid and gaseous fuels. The system is not designed to introduce a secondary low-stoichiometric liquid fuel while modulating intake boost pressures for operating a small displacement engine with adequate power.

The patent to Oprea, U.S. Pat. No. 6,588,406 shows a dual fuel metering system with an electromagnet controlling two valves. Each valve controls the flow of fuel from two separate sources, or tanks. After the valves, the fuels flow through separate paths within the injector. A dividing means maintains separate fuel flow from the valves and through the injector system. From a common seat, the valves are both opened upon energizing the electromagnet which is not a feature of the present invention.

The patent to Goto, U.S. Pat. No. 6,814,032 has a dual fuel engine where each cylinder has a pre-combustion chamber. This dual fuel engine operates on one or both gaseous fuel and diesel fuel. Electromagnetic fuel injectors admit liquid fuel to ignite gaseous fuel while a compression ratio control valve stops introduction of gaseous fuel into the cylinders. As in prior patents, this patent has an engine operating on gaseous or liquid fuels. This differs from the present invention in that the small displacement engine does not require pre-combustion chambers and is operated on a primary liquid gasoline and secondary ethanol or liquid ethanol blend.

The patent application publication to Schute, U.S. No. US2005/0205021, describes a dual fuel engine with diesel as one of the fuels. This engine has two fuel supply and injection systems with separate injectors for the diesel and second fuel, such as LPG. The diesel and second fuel are injected into cylinders during the compression stroke of the piston. The publication does not mention spark plugs or gasoline as a fuel. This publication discloses a diesel and LPG fueled engine but not a gasoline and ethanol fueled engine. This publication also discloses an integrated control unit similar to the ECM in the present invention.

The patent to Funk, U.S. Pat. No. 7,019,626 describes a conversion system for diesel and gasoline engines. This system has an engine with an injection system for diesel or gasoline and a separate system for admitting a second fuel in place of a portion of the first fuel. This system also provides an indicator to the engine operator about the percentage of second fuel to first fuel during usage. Generally, the second fuel in this patent is compressed natural gas, or another petroleum gas.

The patent to Takemoto et al., U.S. Pat. No. 7,228,841 shows a powertrain with a switching system between two fuels. The system supplies a fuel, likely gasoline to the cylinders of an engine. Then it stops the first fuel while maintaining RPM levels in the engine for a predetermined period. Next, it supplies a second fuel to keep the engine operating at the RPM until the first fuel is needed in response to an engine operating condition. The second fuel is likely hydrogen or other petroleum gas. The power train also includes an electric motor to maintain engine RPM during the fuel switchover. This system does not dynamically control an engine under varying loads and RPM levels, and lacks other systems for controlling a small-displacement engine.

Then the U.S. Pat. No. 6,951,202 to Oda shows a knocking control system. This system senses the knock and degree of knock along with the status of the ignition timing in the engine. This system then adjusts the proportions of two fuels supplied, high and low octane, to minimize knocking while maintaining the ignition timing. It does not however modulate intake boost pressures and other engine functions for a small-displacement engine.

The U.S. Pat. No. 4,706,629 to Wineland et al. provides an engine control system for using methanol and gasoline, two fuels of different energy content per unit volume. This system provides a method for determining the fuel air ratio of the two fuels when mixed base on the fuel air ratio of each separate fuel. The system is not designed to modulate intake boost pressures as when operating a small displacement engine with adequate power.

Then the U.S. Pat. No. 7,222,015 to Davis, et al., shows an electronic control unit for an engine and a method for operating the control unit on a dual fuel engine. This patent, generally using diesel fuel and natural gas in the engine, regulates the operation of the engine based on operating characteristics and natural gas fuel properties. This control unit may include checking the boost pressures of the engine however this patented invention generally retains the size of existing engines. This patent invention seeks to lower the emissions of existing engines with minimal retrofitting costs.

The U.S. Pat. No. 5,778,857 to Nakamura et al. has an engine control method of many embodiments. The engine control system determines the instantaneous rate of combustion in at least one chamber. The rate is further specified by values of engine performance input into a linear equation. The rate of combustion measured in the chamber is compared against a map, or three dimensional table, of target combustion rates. As the method adjusts various engine parameters, the method brings the engine to a desired rate of combustion. The parameters include pressure within the combustion chamber, amount of fuel burnt, compression ratio, spark plug firing time, supercharger pressure, operator demand, and throttle position. This patent provides a method of combustion control in contrast to the present invention using boost pressure to regulate delivery of multiple fuels.

The U.S. Pat. No. 7,031,824 to Gangopadhyay has a method for a multivariable controller that communicates with charge handling actuators. The controller receives inputs regarding the oxygen content and pressure of intake air prior to combustion in an engine. The actuators include various turbochargers, valve trains, and throttles. In regulating oxygen content, this method seeks to reduce emissions from an engine. This method though does not describe usage of two fuels nor a power increase as in the present invention.

The U.S. Pat. No. 7,228,824 to Glugla et al. provides a method and devices for regulating engine speed in a variable compression ratio setting. Compression ratio determines the efficiency of an engine in combusting fuel in a cylinder where volume changes with piston position. Also this system is not designed to modulate intake boost pressures in engines with fixed compression ratio and make selective choices between two liquid fuels as when operating a small displacement engine producing adequate power.

And the U.S. Pat. No. 6,148,615 to Vogt et al. shows another method of controlling an engine. This method measures boost pressure and calculates a manipulated variable, as at Idtv, or a signal or an electro-pneumatic timing valve. The manipulated variable, having various signal characteristics is then transformed by the method into a linear signal which is related back to boost pressure. This method seeks to transform a non-linear signal regarding boost pressure measurements into a linear response for operating a valve, without mention dual fuels used in the present invention.

The present invention overcomes the difficulties of the prior art. That is, the prior art has addressed fuel conversion issues in steady-state applications and liquid-to-gas conversions on current engine displacements without the ability to modulate critical functions that make the vehicle operable and with improved cruising fuel mileage and power. The present invention modulates boost pressure as it operates an engine upon two fuels seeking to maximize the benefits of both fuels with the demands upon the engine.

### SUMMARY OF THE INVENTION

Generally, this invention capitalizes on the advantages of both gasoline and a secondary “power” fuel like ethanol, E-85, other alcohols, or like-blended fuels. It features an engine control system that allows the use of a small and efficient engine that is slightly larger than that necessary to produce the power required at cruising speeds common on highways, yet will deliver increased power from the secondary fuel automatically on demand when needed. The combination will provide substantial increases in fuel economy with lowered emissions as compared to current conventional automotive engines and control systems. It also provides other associated operational, environmental, and cost-savings advantages that will be explained in this application.

In this application, the term “primary fuel”, or first fuel, refers to readily available conventional gasoline products. The term “secondary fuel”, or second fuel, includes ethanol, E-85 gasoline, other alcohols, or other like-blended fuels that are liquids at common operating temperatures for automotive use and that have lower stoichiometric ratios and higher octane levels than that of conventional pump gasoline.

The relatively high stoichiometric ratio of primary gasoline fuels make them desirable for low-load cruising conditions. The low flash point of gasoline makes it desirable for starting an engine in very cold weather.

The lower stoichiometric of the secondary fuel creates several power-making advantages. For example, ethanol or E-85 has less BTU content per volume than gasoline, but contain oxygen that promotes cleaner burning. These secondary fuels also have greater latent heat values than conventional gasoline-resulting in better cooling of the engine and fewer problems with destructive detonation or pre-ignition. Ethanol, E-85, and other like alcohol secondary fuels also exhibit very high octane ratings compared to gasoline. These properties mean that an engine running on this secondary fuel can be configured with a turbocharger or supercharger resulting in much higher dynamic compression. The result is far more power-more than twice that produced by the engine on conventional gasoline. Thus, a small displacement engine can be utilized in this invention that still produces impressive power when needed.

Prior to this invention, an engine sized very small for maximum cruising efficiency created insufficient power for higher load conditions like acceleration, towing, or climbing steep hills. This invention overcomes this limitation by a unique “intelligent” control system and corresponding hardware that introduce a secondary “power” fuel while simultaneously increasing intake boost and modulating other engine operating parameters. This results in very sufficient power the higher-load demands like acceleration, towing, and climbing hills.

By combining two fuels and modulating the small displacement engine as described in this invention, it will produce higher fuel efficiency, lower emissions, and exhibit a smaller “carbon footprint” when ethanol or ethanol blends like E-85 are utilized as the secondary (power) fuel.

This is accomplished by a control system that manages the selection, combination, and delivery of separate fuels (primary and secondary) to an engine, while controlling the intake boost pressure of a variable boost turbocharged or supercharged system. It will also modulate fuel mixture ratios and spark timing to levels that are unique to the particular small-displacement engine built around this invention.

Associated sensors and hardware allow the use of an engine that can cruise or operate under light load with greater fuel efficiency, yet would produce adequate power for higher load conditions. When more power is required, this system increases engine power substantially, but only for the duration for which it is required. The net result will be improved fuel economy during highway and mixed-driving use. Other benefits of the present invention include reduced emissions and reducing the usage of petroleum, particularly imported oil.

One likely choice for the secondary (power) fuel in the invention is E-85. E-85 is an increasingly available and popular fuel that provides substantial advantages when configuring an induction boost system. E-85 fuel has an octane number rating of 105, well above that of gasoline. The lower stoichiometric ratio for E-85 shows that the fuel will also cool the intake charge much more quickly than gasoline because of the greater latent heat of vaporization. These two properties of E-85 or other ethanol-enhanced fuels as the secondary fuel reduce the common problem of high boost pressure systems including detonation (knocking). However, the invention is not limited to the use of E-85 as the secondary (power) fuel.

The present invention, operating on a more power-efficient fuel and higher boost pressure, permits a small engine to produce enough power for high load conditions as an existing engine. Such high load conditions exclude most cruising conditions and other low load vehicle operations. The present invention increases power as it is required, substantially for the duration of usage. The net result of the present invention shows improved fuel economy during highway usage and mixed distance driving.

The present invention, a system with sensors, processing, and actuators, monitors necessary vehicle parameters so that the electronic engine control system (ECM) determines the status of the engine as startup, light-load demand, heavier load demand, and the like.

In the preferred embodiment of the invention, it delivers either fuel through dedicated sets of fuel injectors, one set with one injector per cylinder for the primary fuel (gasoline) and one set with one injector per cylinder for the secondary (power) fuel. However, the invention is not limited to the use of port-type injectors (one injector per cylinder) and may utilize injectors that serve multiple cylinders. This can include the use of a throttle body injector system (TBI), in which a single, centrally located injector source serves multiple cylinders.

Upon making the determination of engine status and load, the electronic engine control system (ECM) selects the primary fuel (gasoline) for light-load cruising conditions. The present invention also remedies the cold starting difficulties of vehicles using E-85 fuel. At ambient temperatures below 10° F., E-85 fuel in existing “Flex Fuel” vehicles is difficult to vaporize and engines become more difficult to start. Vehicle operators who reside in cold climates and have E-85 fuels or other high-ethanol content fuels in their tank thus use engine heaters to ensure engine starting on a cold morning. The present invention overcomes this problem by always starting the engine on gasoline that vaporizes faster and thereby starts much more easily in cold conditions.

On higher load demands, the control system will quickly introduce a secondary fuel from a separate fuel supply. The use of a primary fuel (gasoline) in conjunction with the very small and efficient engine creates the improved fuel economy while driving under cruise and light-load conditions. Drivers of vehicles equipped with this control system and components that do the majority of their driving on highways and at cruising speeds will realize the greatest benefits of this system in the form of high rates of fuel economy.

When more power is needed than can be supplied by the small displacement engine running on gasoline, the electronic engine control system (ECM) senses this and makes the appropriate fuel selection. It also increases intake boost through a variable turbocharger or supercharger to increase power for acceleration and load and monitors engine operation under these conditions. If the applied algorithms for monitoring these issues are found outside of parameters, the ECM will make the needed changes to intake boost pressure, fuel source, fuel mixture, and spark timing.

Part of the on-demand power level increase results from the lower stoichiometric ratio and higher octane ethanol or ethanol-enhanced fuel, while the remainder occurs from increased dynamic intake pressures. The system maintains low-load power levels with low or no-intake boost pressures and runs the engine through fuel injectors primarily on ordinary pump gasoline. For conditions requiring an increased power level from the baseline level, it increases intake pressures (boost) and simultaneously reduces or eliminates associated high-boost problems by the introduction of a secondary ethanol-enhanced fuel through a second set of fuel injectors.

An important aspect of the control system quickly senses the required power demands and chooses the appropriate fuel, boost pressure, mixture ratios, ignition timing, and the like. It accomplishes quickly and avoids acceleration lag and operating parameters that damage or shorten the life of internal engine components. The turbocharger (or supercharger) will be designed and sized for a high dynamic range in boost pressures that will help minimize lag issues.

The present invention will also sense other conditions such as heat or detonation, and pre-ignition that would warrant the introduction of the secondary fuel for protective measures should any system component begin to operate outside of safe parameters. The ECM is programmed to inform the driver of this condition by an illuminated light, sound, or text message. Once sensor inputs are processed indicating that the protective measures are no longer required (the algorithms are once again within normal operating parameters), the ECM reverts back to normal engine control parameters.

In the event that one or the other of the two fuels is in low supply or completely gone, the ECM is programmed to inform the driver of this condition by an illuminated light, sound, or text message. The algorithms programmed into the ECM and its controls provide for the use and operation of the engine on only one of the two fuels, or in combination of both so that the vehicle remains operational.

The ECM will monitor fuel tank levels for both the primary and secondary fuels. If programmed parameters for the vehicle in the ECM determine that one fuel is in short supply, the ECM will make the needed adjustments to fuel selection and operating mode. The ECM is programmed to inform the driver of this condition by an illuminated light, sound, or text message. For example, if the secondary fuel is in short supply, the ECM uses less of the secondary fuel in conjunction with the primary gasoline fuel and modulates (lowers) boost pressures accordingly to help preserve that fuel supply. The driver may notice a reduction in full power, but the vehicle safely reaches a station for refueling.

There has thus been outlined, rather broadly, the more important features of the invention in order that the detailed description thereof that follows may be better understood and that the present contribution to the art may be better appreciated. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a control system that modulates engine power from a small displacement engine by controlling intake boost pressure.

Another object is to control and administer dual-fuels to operate the small displacement engine with both efficiency and power under controls that do not damage the engine and with minimal lag in throttle response.

Another object is to provide such a dual-fuel small volume engine that operates on conventional pump gasoline and E-85 ethanol or other ethanol-enhanced fuels.

Another object is to provide such a dual fuel small volume engine that provides substantial power but also improved fuel mileage and lower emissions when compared to similar vehicles that do not use the invention.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings:

FIG. 1 describes a top view of the preferred embodiment of the present invention, separate from a vehicle; and,

FIG. 2 shows a circuit diagram for the electronic control module of the preferred embodiment.

The same reference numerals refer to the same parts throughout the various figures.

### DESCRIPTION OF THE PREFERRED EMBODIMENT

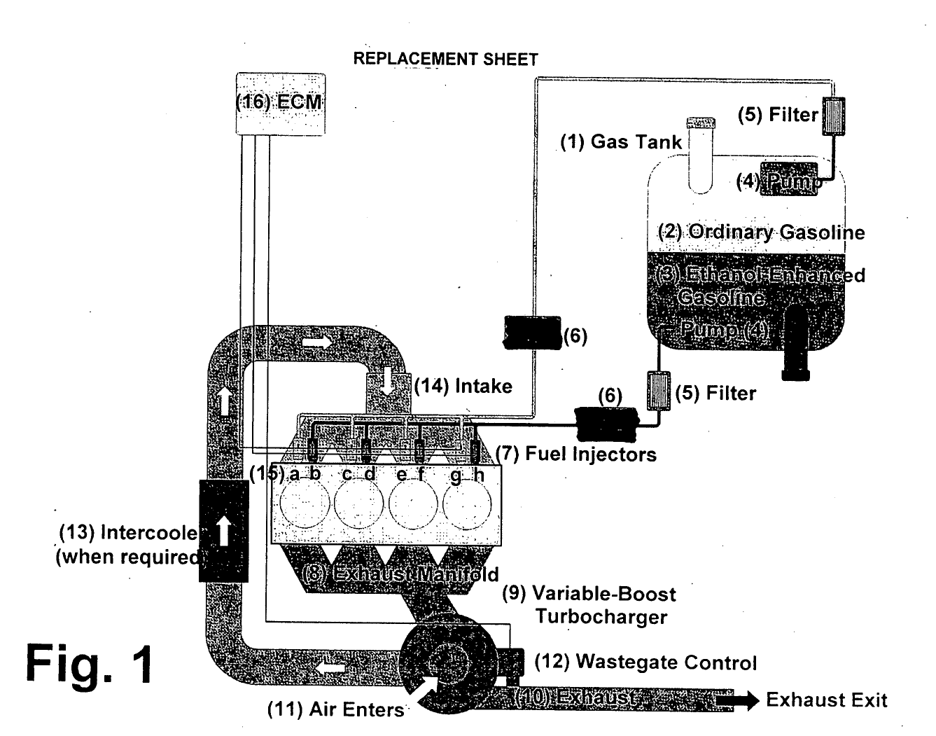

The present invention overcomes the prior art limitations and provides a control system for a boost-modulated dual-fuel small volume engine that provides similar or increased power and reduced emissions when compared to a larger engine while using a secondary fuel such as ethanol or E-85. The same system provides for improved cold starting and improved fuel mileage under most low-load and cruising conditions by modulating intake boost pressures and operating the engine with a dedicated set of injectors on gasoline during these conditions. The preferred embodiment of the present invention 1 is shown in FIG. 1, ready for installation in a vehicle.

The present invention has primary fuel, gasoline, supplied from a tank (1), or tank division, and secondary fuel, E 85 or other ethanol-enhanced fuel, supplied from a tank (1) installed upon the vehicle. The preferred embodiment has a single tank (1), but with two separate chambers, a gasoline chamber (2) and an E 85 chamber (3). The chambers are not in mutual fluid communication. Gasoline is supplied from the chamber (2) by an electrically powered pump (4) that transmits the gasoline through a filter (5). Following the filter, the gasoline travels by a fuel line to a pressure regulator (6). The E 85 is supplied from the other chamber (3), also by an electrically powered pump that separately transmits the E 85 through a filter (5). Beyond the filter, the E 85 passes through a fuel line to another pressure regulator. From the pressure regulators, the gasoline and E 85 serve as the fuel for the engine (7) of the present invention, here shown with four cylinders, but other embodiments of the invention may include any number of cylinders.

Following combustion of the primary gasoline fuel and the secondary fuel when supplied, the exhaust gases are evacuated from the cylinders through the exhaust manifold (8). The manifold (8) collects the exhaust gases and discharges them through a common tube to the turbocharger (9). The turbocharger utilizes the heat and pressure of the exhaust gases to rotate a turbine blade at high speed that drives a second set of blades that act as a pump. The pump side draws atmospheric air through an intake (11) and pressurizes it for delivery to the engine. A wastegate control (12) allows continuous modulation of exhaust flow to regulate the resulting intake pressures. The exhaust gases, having surrendered heat and pressure to the turbocharger, then enter the exhaust system (10) for eventual release to the atmosphere. This invention may contain additional sensors and control systems that may monitor other engine operating parameters, such as intake and turbo discharge temperatures, and intake air density, among others.

The pressurized air flows from the intake (11) through tubing, or hoses, to various devices proximate the engine, including in some embodiments an intercooler (13). Beyond the various devices, the pressurized air enters the intake manifold (14) through a common pipe and then become divided and supplied to the intake valves of each cylinder. During the intake stroke of each piston, pressurized air enters the cylinder along with primary or secondary fuel. The fuels enter through separate injection systems (15) where each cylinder has an injector for each fuel. The gasoline injectors are shown as (15a, c, e, g) while the E-85 injectors are seen at (15b, d, f, h). Delivery of the fuel and control of the engine occurs through an electronic control module (16), or ECM.

The ECM as at (16) regulates various features of the invention, including the type of fuel, pressure and volume of fuel supply, engine performance, and failsafe modes of fuel usage and engine control when one of two chambers empties, among other things. The present invention primarily relies upon increasing boost pressure in the presence of E 85 fuel for heightened power from the small displacement engine, on par or exceeding that of larger, naturally aspirated engines. The boost pressure arises from the turbocharger (9), or a mechanically-driven supercharger, and is measured and controlled by the ECM. Additionally, the wastegate control also regulates intake pressure subject to oversight by the ECM. In tandem with boost pressure regulation, the ECM also electrically energizes and regulates fuel delivered by the two discreet sets of injectors (15a-h). The fuel pumps (4) provide a continuous supply of fuel through the pressure regulators (6).

At engine startup and light cruise conditions, the ECM operates only the primary fuel (gasoline) injectors (15a, c, e, and g), or one per engine cylinder, and only gasoline is administered and consumed by the engine. At this time, the ECM also regulates intake pressures though wastegate (12) modulation so that the engine does not spark knock. Spark knocking may be monitored by a “knock sensor” (not shown) that reports knocking conditions to the ECM. During startup and light cruise conditions, the ECM monitors other functions such as fuel mixture, spark timing, and the like.

Engine load will be quantified in the computer ECM by applying algorithms to inputs from sensors including throttle position, engine coolant temperature, engine RPM's, manifold absolute pressure, intake mass airflow, intake charge temperature, vehicle speed, transmission gear range, knock sensor, and wastegate position. When that load by application of application-specific algorithms exceeds what can effectively be produced on gasoline fuel and the corresponding low-boost pressure alone, the ECM operates a second set of injectors (15b, d, f, h). In this condition of load, and depending on the severity of the load demand, that administer E-85 or ethanol-enhanced fuel to the engine. The set of primary fuel (gasoline) injectors (15a, c, e, and g) may continue to be operated by the ECM and continue to deliver fuel to the engine, or they may be phased out or shut off completely for higher engine load demands. The ECM will simultaneously increase intake boost pressure by modulation of the wastegate (12) and make changes and corrections to fuel mixtures, including the relative proportions of both the primary (gasoline) fuel and the secondary (ethanol-enhanced) fuel. An oxygen sensor provides closed-loop feedback to the ECM so that the correct fuel mixture is maintained.

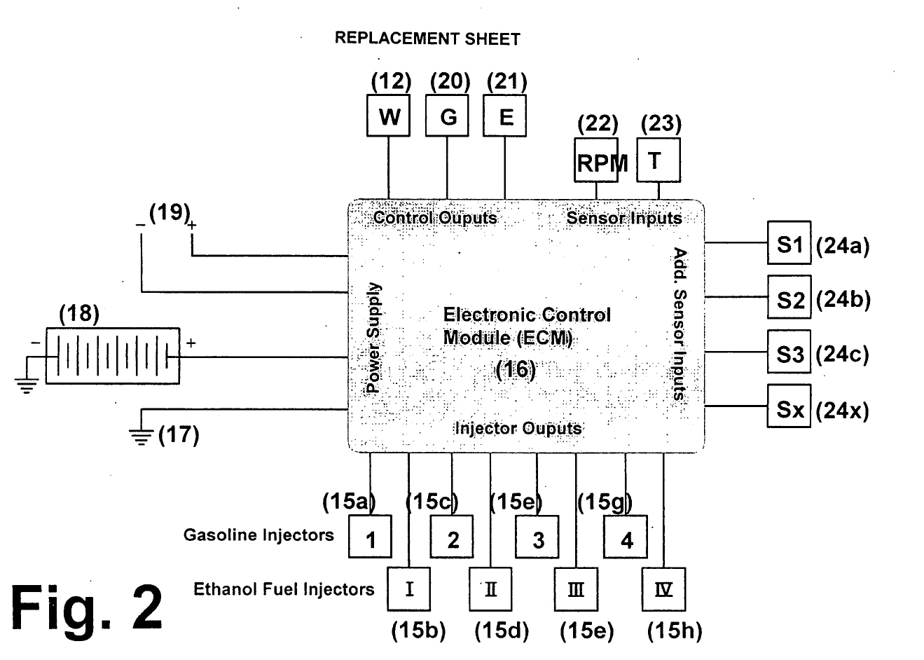

Having described the components and operation of the engine of the present invention, FIG. 2 shows the ECM (16) and some, but not necessarily all, of its related inputs and outputs in a modified block diagram. The ECM receives power from either battery storage (18), as during initial starting of the engine, or from current (19) supplied by the vehicle's charging system. The ECM also has a ground (17) in cooperation with the grounding system of the vehicle. When powered, the ECM receives information about the fuel and engine performance from the various sensors (24a-24x) including throttle position, engine coolant temperature, engine RPM's, manifold absolute pressure, intake mass airflow, intake charge temperature, vehicle speed, transmission gear range, knock sensor, and wastegate position). Additional sensors are represented in the diagram by (24x), indicating additional sensors may be utilized in future embodiments of the invention as required to provide the ECM with adequate information to make the appropriate calculations and commands to controllers.

Fuel level sensors (and in some cases ethanol content sensors) as at (20) for gasoline and fuel level sensors (and in some cases ethanol content sensors) as at (21) for E-85 or other ethanol-enhanced fuel provide the ECM with information about how much fuel remains in the chambers (2, 3), particularly when a chamber becomes empty. When a chamber empties, the ECM defaults to supplying fuel from the other chamber or operates the engine with reduced amounts of the low supply fuel and makes necessary engine operating changes as described above. In any situation of low or no fuel level, the ECM will also illuminate a warning light, sound, or text message to inform the driver of the condition (“low-fuel” light or other visual display).

As the present invention utilizes an engine that is not only smaller in displacement, but also smaller in overall dimensions, the engine compartment and related structures of the vehicle can be reduced as a result of the system described in this patent. A smaller engine compartment can lead to a lighter overall vehicle weight and improved aerodynamics resulting in additional improvements in fuel mileage and possibly further decreased emissions. Utilizing gasoline and E-85 in the appropriate load conditions, the present invention maximizes the strengths of each fuel.

From the aforementioned description, a dual fuel small displacement engine control system has been described. This engine is uniquely capable of utilizing both gasoline and E-85 ethanol fuel coupled with increased intake pressure from boost pressure. This engine provides the necessary power at both high and load conditions but with at least one third less cylinder volume. The dual fuel small volume engine and its various components may be manufactured from many materials, including but not limited to, polymers, polyvinyl chloride, high density polyethylene, polypropylene, steel, ferrous and non-ferrous metals, their alloys, and composites, along with assembling the invention by welding, mechanical fasteners, or adhesives.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A system operating an engine upon two fuels using heightened boost pressure and the secondary fuel to provide equivalent power as the primary fuel, comprising:
an engine having at least two cylinders, an exhaust manifold, at least a turbocharger, a wastegate control relating to said turbocharger, and an intake manifold;
a source for the primary fuel;
a source for the secondary fuel;
a delivery system for the primary fuel;
a delivery system for the secondary fuel; and,
an engine control module having algorithms and parameters commanding delivery of said secondary fuel to said engine at a higher boost pressure when detecting a high load demand condition upon said engine, and alternatively commanding delivery of said primary fuel to said engine when detecting a low load demand condition upon said engine.

2. The engine operating system using two fuels of claim 1 wherein said primary fuel is gasoline of at least 85 octane.

3. The engine operating system using two fuels of claim 2 wherein said secondary fuel has a lower stoichiometric ratio than that of gasoline and has at least 100 octane.

4. The engine operating system using two fuels of claim 1 further comprising:
a revolutions per minute sensor measuring said engine;
a throttle position sensor;
a manifold pressure sensor;
an intake boost pressure sensor;
an airflow sensor;
a transmission gear range sensor;
a fuel sensor measuring the level of said primary fuel in its source; and, another fuel sensor measuring the level of said secondary fuel in its source.

5. The engine operating system using two fuels of claim 4 further comprising:
said engine control module receiving and processing input from:
said revolutions per minute sensor,
said throttle position sensor,
said manifold pressure sensor,
said transmission gear range sensor,
said throttle position sensor,
said manifold pressure sensor,
said airflow sensor,
said transmission gear range sensor,
said fuel sensor measuring the level of said primary fuel in its source, and,
said other fuel sensor measuring the level of said secondary fuel in its source;
said engine control module receiving intake boost pressure readings from a sensor with said wastegate control modulating this boost pressure;
said engine control module determining engine load demands by application of algorithms and parameters operating upon sensed changes in operation of said engine;
said engine control module, once having determined the state of said engine, commands higher intake boost pressure through operation of said waste gate control, and delivers one of said primary fuel or said secondary fuel to said engine; and,
said engine control module commanding said delivery system of said primary fuel to supply said primary fuel to said engine when said sensor of said secondary fuel detects an absence of said secondary fuel in the tank, and alternatively commanding said delivery system of said secondary fuel to supply said secondary fuel to said engine when said sensor of said primary fuel detects an absence of said primary fuel in the tank.

6. The engine operating system using two fuels of claim 5 further comprising:
said delivery system of said primary fuel delivering to each of said cylinders; and,
said delivery system of said secondary fuel delivering to each of said cylinders separately from said delivery system of said primary fuel.
